(19) United States
(12) Patent Application Publication
(10) Pub. No.: US 2025/0353228 A1
(43) Pub. Date: Nov. 20, 2025

(54) MANIFOLD INSULATION AND SECURING MEANS

(71) Applicant: SYNVENTIVE MOLDING SOLUTIONS, INC., Peabody, MA (US)

(72) Inventors: Salvatore A. LoGrasso, Beverly, MA (US); Deven Hansen, Atkinson, NH (US); Michael Lewis Vasapoli, Gloucester, MA (US)

(21) Appl. No.: 18/666,182

(22) Filed: May 16, 2024

(51) Int. Cl. B29C 45/26; B29C 33/70; B29C 45/20; B29C 45/27

(52) U.S. Cl. CPC B29C 45/2675; B29C 33/70; B29C 45/20; B29C 45/2725; B29K 2907/04; B29K 2995/0015

(57) ABSTRACT

An injection molding apparatus includes a cavity, a component removably mountable within the cavity, and a covering. The covering is positionable about the component. The covering and the component are removably installable within the cavity.

### FIELD

Exemplary embodiments of the present disclosure relate to insulation for use with a manifold of an injection molding apparatus, and more particularly to a mechanism for securing the insulation in position.

### BACKGROUND

Manifolds of existing injection molding machines are not typically insulated. However, insulating the manifold can maintain the manifold at an elevated temperature, thereby reducing the power consumption or energy required to heat the manifold. In systems where the manifold is insulated, the insulation material is difficult to install. Such insulation material is typically attached to the manifold via metal zip ties. However, these zip ties are only suitable for a single use. Accordingly, to perform maintenance on the manifold, the existing zip ties must be destroyed to remove the insulation from the manifold, and upon completion of maintenance, new zip ties must be installed to reattach the insulation about the manifold.

### BRIEF DESCRIPTION

According to an embodiment, an injection molding apparatus includes a cavity, a component removably mountable within the cavity, and a covering. The covering is positionable about the component. The covering and the component are removably installable within the cavity.

In addition to one or more of the features described herein, or as an alternative, in further embodiments the covering extends about an entire periphery of the component at one or more locations along a longitudinal axis of the component.

In addition to one or more of the features described herein, or as an alternative, in further embodiments the covering extends about only a portion of a periphery of the component at one or more locations along a longitudinal axis of the component.

In addition to one or more of the features described herein, or as an alternative, in further embodiments the covering forms a liner about the cavity.

In addition to one or more of the features described herein, or as an alternative, in further embodiments the covering includes a body formed from a non-rigid, insulative material and a first portion of at least one attachment mechanism affixed to the body. The first portion of the at least one attachment mechanism is connectable to a second portion of the at least one attachment mechanism to position the covering about the component.

In addition to one or more of the features described herein, or as an alternative, in further embodiments the second portion of the at least one attachment mechanism is affixed to the body.

In addition to one or more of the features described herein, or as an alternative, in further embodiments the second portion of the at least one attachment mechanism is affixed to a sidewall of the cavity.

In addition to one or more of the features described herein, or as an alternative, in further embodiments the second portion of the at least one attachment mechanism is affixed to the component.

In addition to one or more of the features described herein, or as an alternative, in further embodiments the component is a manifold.

In addition to one or more of the features described herein, or as an alternative, in further embodiments the component is a nozzle.

In addition to one or more of the features described herein, or as an alternative, in further embodiments an attachment mechanism is separate from the covering. The attachment mechanism is positionable in overlapping arrangement with the covering to removably couple the covering to the component.

In addition to one or more of the features described herein, or as an alternative, in further embodiments the covering is formed from a carbon felt material.

According to an embodiment, a covering for use with a component of an injection molding apparatus includes a body formed from a non-rigid, insulative material and a first portion of at least one attachment mechanism affixed to the body. The first portion of the at least one attachment mechanism is removably engageable with a second portion of the at least one attachment mechanism. When the first portion of the at least one attachment mechanism is connected to the second portion of the at least one attachment mechanism, at least a portion of the component is surrounded by the body.

According to an embodiment, a method of performing maintenance on a component of an injection molding apparatus includes accessing a cavity within which the component is positioned, removing the component from the cavity, decoupling at least one attachment mechanism to separate a covering from the component, and recoupling the covering to the component via the at least one attachment mechanism.

In addition to one or more of the features described herein, or as an alternative, in further embodiments the decoupling the at least one attachment mechanism includes separating a first portion of the at least one attachment mechanism from a second portion of the at least one attachment mechanism.

In addition to one or more of the features described herein, or as an alternative, in further embodiments the second portion of the at least one attachment mechanism is affixed to the covering.

In addition to one or more of the features described herein, or as an alternative, in further embodiments the second portion of the at least one attachment mechanism is affixed to the component.

In addition to one or more of the features described herein, or as an alternative, in further embodiments the second portion of the at least one attachment mechanism is affixed to a sidewall of the cavity.

In addition to one or more of the features described herein, or as an alternative, in further embodiments the covering remains within the cavity during the removing the component from the cavity.

In addition to one or more of the features described herein, or as an alternative, in further embodiments the decoupling at least one attachment mechanism includes sliding the at least one attachment mechanism out of engagement with the covering.

### BRIEF DESCRIPTION OF THE DRAWINGS

The following descriptions should not be considered limiting in any way. With reference to the accompanying drawings, like elements are numbered alike:

FIG. 1A is a cross-sectional schematic view of an injection molding apparatus according to an embodiment;

FIG. 1B is a cross-sectional schematic view of an injection molding apparatus having a pair of remotely mounted actuators interconnected to a pair of valve pins according to another embodiment;

FIG. 2 is a perspective view of a manifold having a covering positioned about but not affixed to the manifold according to an embodiment;

FIG. 3 is a plan view of a covering of a manifold in an uninstalled configuration according to an embodiment;

FIG. 4 is a perspective view of a manifold cavity having a covering installed therein according to an embodiment;

FIG. 5 is a schematic cross-sectional view of a manifold enclosed by a covering affixed to itself according to an embodiment;

FIG. 6 is a schematic cross-sectional view of a manifold partially enclosed by a covering affixed directly to the manifold according to an embodiment.

FIG. 7 is a schematic cross-sectional view of a manifold partially enclosed by a covering affixed to a sidewall of the manifold cavity according to an embodiment;

FIG. 8 is a schematic cross-sectional view of a covering arranged as a liner of a manifold cavity according to an embodiment;

FIG. 9 is a perspective view of a covering associated with a nozzle in a first configuration according to an embodiment.

FIG. 10 is a perspective view of the representative nozzle of FIG. 9 as the covering is transformed between the first configuration and a second configuration according to an embodiment;

FIG. 11 is a perspective view of the representative nozzle of FIG. 9 with the covering in the second configuration according to an embodiment; and

FIG. 12 is a cross-sectional view of a nozzle and a covering according to another embodiment.

### DETAILED DESCRIPTION

A detailed description of one or more embodiments of the disclosed apparatus and method are presented herein by way of exemplification and not limitation with reference to the Figures.

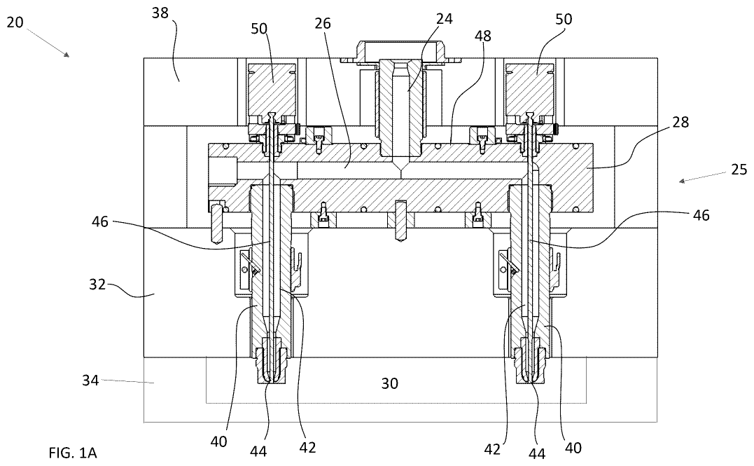

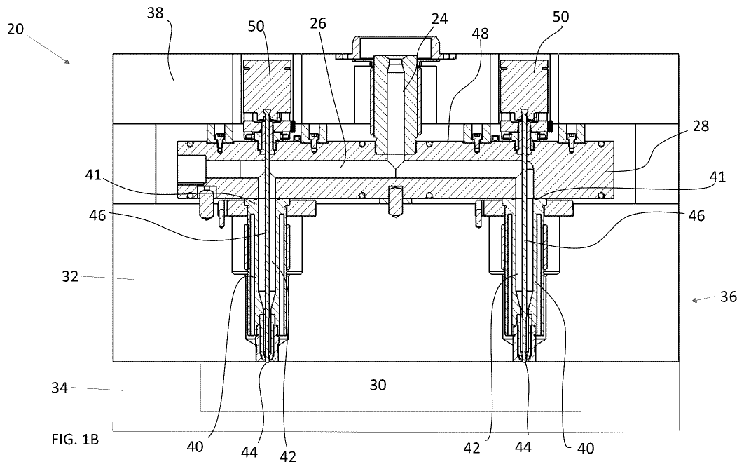

With reference to the FIG. 1A, a non-limiting example of a system or apparatus 20 for forming an injection molded part is provided. As illustrated, the apparatus 20 includes nozzle interface 24 configured to receive a molten injection fluid from an injection nozzle (not shown) and provide it the molten injection fluid to a mold 25. The nozzle interface 24 is arranged in fluid communication with a distribution channel 26 of a hot runner manifold 28 operable to control the flow of injection fluid into a cavity 30. Although only a single cavity 30 is illustrated in the FIG., it should be appreciated that in other embodiments, the injection fluid is deliverable into a plurality of cavities. In the illustrated, non-limiting embodiment, the cavity 30 is defined by two mold plates 32, 34. However, embodiments where the cavity 30 is formed by a single mold plate are also within the scope of the disclosure. The hot runner manifold 28 is a heated manifold and as shown, may be disposed between an upstream clamp plate 38 and the mold plate 34.

The apparatus 20 for forming an injection molded part may additionally include one or more nozzles 40 generally positioned within or adjacent to a portion of the mold 25, such as mold plate 32 for example. As shown, each nozzle 40 may be positioned such that an outlet end thereof is positioned adjacent to the cavity 30. The at least one nozzle 40 has one or more nozzle channels 42 formed therein. The nozzle channel 42 may be fluidly coupled to both the distribution channel 26 and the cavity 30 to provide as flow path for the injection fluid from the distribution channel 26 to the cavity 30. In the embodiment illustrated in FIG. 1A, the nozzles 40 are threadably connected to the manifold 28. However, in other embodiments, such as shown in FIG. 1B, an upstream end 41 of the nozzle 40 may abut an outer surface of the manifold 28 and the nozzle 40 may be clamped within a nozzle channel 42 between the manifold 28 and the mold plate 32.

The injection fluid is routed into the cavity 30 via one or more downstream gates 44 formed at an outlet end of each nozzle channel 42. A valve pin 46 arranged within each nozzle channel 42 is operable to control the flow of fluid through the downstream gate 44 to the cavity 30. In an embodiment, the valve pin 46 arranged within each nozzle channel 42 is movable between a first position and a second position. Accordingly, when the valve pin 46 is in the first position, the gate 44 is closed and when the valve pin 46 is in the second position, the gate 44 is open. The gate 44 may be closed when the valve pin 46, in the first position, extends to the outlet end of the nozzle channel 42, thereby blocking the flow of fluid through the nozzle channel 42. The gate 44 is open when the valve pin 46, in the second position, is separated or spaced from the outlet end of the nozzle channel 42, thereby allowing fluid to freely flow through the nozzle channel 42 into the cavity 30. In the illustrated, non-limiting embodiment, the valve pin 46 is translatable or movable linearly between the first and second position. However, embodiments where the valve pin 46 is movable in another suitable manner to selectively close and open the gate 44 are also within the scope of the disclosure.

At the start of an injection cycle, a valve pin 46 may be positioned such that the gate 44 is completely open and at the end of an injection cycle, the valve pin 46 may be positioned to completely close the gate 44. Further, it should be appreciated that the valve pin 46 may be arranged at any intermediate position between the first position and the second position associated with the fully open and fully closed gate 44. Such intermediate positions of the valve pin 46 may variably increase or decrease the flow rate of the injection fluid into the cavity 30.

A motion device 50 may be associated with at least one valve pin 46 and is operable to control the movement of the valve pin 46 to selectively open and close a corresponding gate 44. In an embodiment, as shown in the FIGS., the motion device 50 is mounted to an upper surface 48 of the manifold 28. It should be appreciated that in other embodiments, the motion device 50 may be arranged at another suitable location about the system 20, such as at a surface of the upstream clamp plate 38, or alternatively, at a location remote from the mold 25 (remote from mold plates 32, 34, manifold 28, and clamp plate 38). In embodiments where the at least one motion device 50 is arranged at the mold 25, the at least one motion device 50 may be mechanically coupled to the injection molding system 20 via any suitable connection mechanism, such as a fastener or bolt for example. Further, the at least one motion device 50 may be operably coupled to one or more valve pins 46 in any suitable manner, such as via a quick connection or a linear motion converter for example.

It should be appreciated that the injection molding apparatus 20 illustrated and described herein is intended as an example only and that an injection molding system having another suitable configuration is also within the scope of the disclosure. Other examples of suitable injection molding systems include a thermal gate system that does not have any valve pins 46 and a “hot half” runner system where the manifold 28 is held in place by a retainer plate rather than by the mold (i.e., mold plate 32 or clamp plate 38).

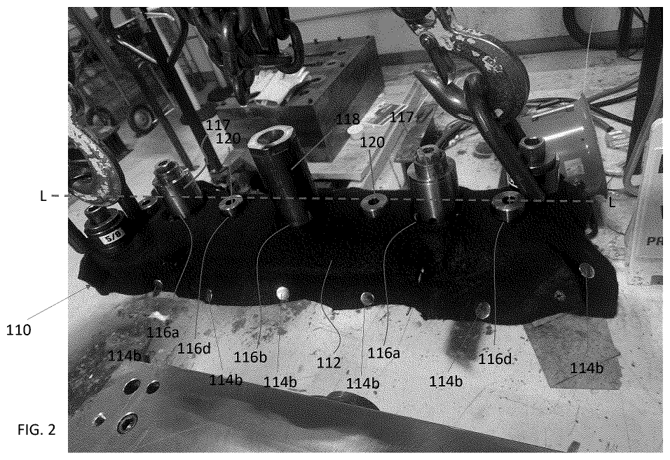

During an injection molding operation, the manifold, such as manifold 28 for example, is typically heated to an elevated temperature between about 300° F. and about 800° F., such as between about 400° F. and about 600° F. for example. It is desirable to maintain the manifold at an elevated temperature between sequential deposits of material into a cavity 30 to reduce the energy required to repeatedly, intermittently heat the manifold. Accordingly, with reference now to FIGS. 2-8, in an embodiment, a covering 110 is positionable about at least a portion of a manifold, shown at 100, and may be arranged within a manifold cavity 106 to retain heat at the manifold 100. The covering 110 may be made from any suitable insulative material with a low thermal conductivity and/or a high heat resistance. In an embodiment, the covering 110 is formed from a non-rigid material, such as a fabric for example. Examples of suitable materials incorporated into such a fabric include, but are not limited to felt, wool, fiberglass, plastic or natural fibers, acrylic, silica, vermiculite, and black slag. In an embodiment, the covering 110 includes a carbon felt material.

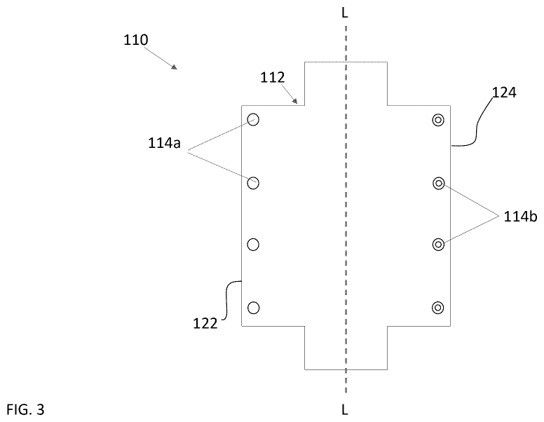

As shown in FIGS. 2 and 3, the covering 110 includes a body 112 and one or more attachment mechanisms 114 for mounting the covering 110 about the manifold 100. The body 112 of the covering 110 may be generally complementary to at least a portion of the manifold 100 such that the body 112 can be wrapped about a least a portion of the manifold 100. For example, a length of the body 112 extending along a longitudinal axis L may be equal to or even greater than a length of the manifold 100. In an embodiment, the length of the body 112 is greater than the length of the manifold 100 such that a portion of the covering 110 may be wrapped about one or more longitudinal ends 102, 104 of the manifold 100. However, embodiments where the length of the body 112 is less than the length the manifold 100 are also within the scope of the disclosure. Similarly, a width of the body 112 may be equal to our greater than a periphery or circumference of the manifold 100 at a respective location along the longitudinal axis L. However, embodiments where a width of the body 112 is less than the periphery of the manifold 100 at any given location along the longitudinal axis L are also contemplated herein. The thickness of the covering 110 is generally less than the air gap created between the manifold 100 and the sidewalls 126 of the manifold cavity 106 within which the manifold 100 is positioned.

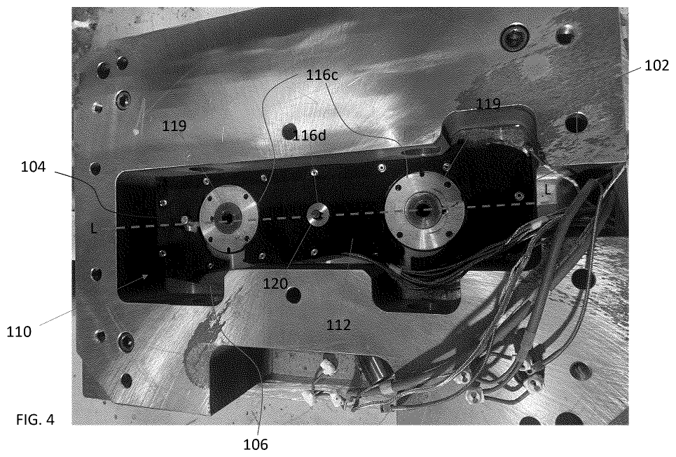

The body 112 of the covering 110 may have one or more openings or holes formed therein, such as to receive a corresponding component of the injection molding apparatus 20. In the illustrated, non-limiting embodiment of FIG. 2, the body 112 of the covering 110 includes at least one hole 116a sized and positioned to receive an actuator interface support 117, such as used to mount a motion device, such as motion device 50 for example, to the manifold 100. Alternatively, or in addition, the body 112 of the covering 110 may include one or more openings 116b for receiving an inlet or nozzle interface 118 fluidly connectable to an upstream end of the distribution channel (not shown) of the manifold 100. In an embodiment, the covering 110 includes one or more openings 116c (FIG. 4) through which a nozzle 119 is fluidly connectable to a downstream end of the distribution channel (not shown) of the manifold 100. Another opening 116d may be formed in a portion of the covering 110 to receive a locating dowel 120, such as used to position the manifold 100 within the manifold cavity 106.

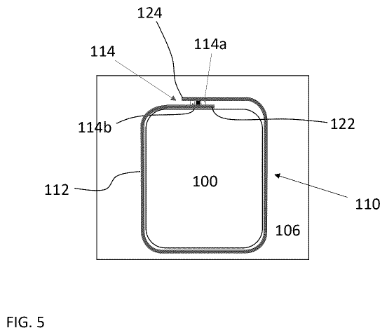

With continued reference to FIGS. 2-8, in an embodiment, the covering 110 is transformable between a first, uninstalled configuration, such as shown in FIGS. 2-3 for example, and a second, installed configuration shown in FIGS. 5-8. When the covering 110 is uninstalled, the body 112 of the covering 110 may have a generally planar configuration. In the installed configuration, the covering 110 may surround or wrap about at least a portion of a periphery of a manifold 100, such as at least 50% of the periphery of the manifold 100 for example, when the manifold 100 is arranged within the manifold cavity 106. The covering 110 may surround the substantially entire periphery of the manifold 100 at one or more locations along a longitudinal axis L of the manifold 100, and in some embodiments may surround the substantially entire periphery of the manifold 100 over the entire longitudinal axis L.

In an embodiment, the insulative covering 110 is removably installable relative to the manifold 100. One or more attachment mechanisms 114 may be used to removably install the covering 110 about the manifold 100. As used herein, the term “removably installable” is intended to refer to embodiments where the covering 110 can be repeatedly installed and removed without damaging the covering 110, the manifold 100, or the one or more attachment mechanisms 114 (described below) used to install the covering 110 at a desired position relative to the manifold 100 or manifold cavity 106. In some embodiments, a plurality of attachment mechanisms 114 may be used to install the covering 110. In such embodiments, the attachment mechanisms 114 may be spaced uniformly or non-uniformly about the body 112.

An attachment mechanism 114 may be formed by one or more first portions 114a and one or more second portions 114b that are selectively engageable to form a connection. The first portion 114a of an attachment mechanism 114 may be directly connectable to a respective second portion 114b of an attachment mechanism 114. Examples of suitable attachment mechanisms 114 include, but are not limited to, snaps, hook and loop fasteners such as Velcro®, buckles, twist fasteners, ties, grommets, buttons, zippers, adhesive tape, and magnets. For example, the stud of a snap may be considered a first portion and a cap of a snap may be considered a second portion. Similarly, the hook side of a fastener may be considered the first portion and the loop side of a fastener may be considered a second portion, or a magnet having a first polarity may be considered a first portion and a magnet having a second polarity may be considered a second portion.

The number of first portions 114a of at least one attachment mechanism 114 associated with the covering 110 may but need not be equal to the number of second portions 114b of the at least one attachment mechanism 114 associated with the covering 110. In an embodiment, a plurality of first portions 114a of an attachment mechanism 114 may be associable with a corresponding single second portion 114b of the attachment mechanism 114. Alternatively, a single first portion 114a of an attachment mechanism 114 may be connectable to a plurality of second portions 114b of a respective attachment mechanism 114. For example, two or more separate hook pieces may be connectable to the same loop piece. In such embodiments, a configuration of the first portions 114a and the second portions 114b may be different.

In the illustrated, non-limiting embodiment of the covering 110 shown in FIG. 3, the covering 110 includes at least one first portion 114a and at least one second portion 114b of an attachment mechanism 114. As shown, a plurality of first portions 114a may be arranged at or proximate to a first edge 122 of the body 112 of the covering 110 and a plurality of second portions 114b may be arranged at or proximate to an opposite edge 124 of the body 112. The edges 122, 124 may be oriented parallel to the longitudinal axis L of the manifold 100 for example. It should be understood that the positioning of attachment mechanisms 114 or portions thereof about the body 112 of the covering 110 may depend on the type of attachment mechanism 114 being used and the desired configuration, such as amount of wrap for example, of the covering 110 about the manifold 100. Further, as will be described in more detail below, in some embodiments, the covering 110 may include only the first portion 114a of one or more attachment mechanisms 114 or may include only the second portion 114b of one or more attachment mechanisms 114. In such embodiments, as will be, the portion of an attachment mechanism 114 arranged at the covering 110 is connectable to another portion of an attachment mechanism 114 located remotely from the covering 110, such as at a location within the manifold cavity for example 106.

In an embodiment, as shown in FIG. 5, the covering 110 is connectable to the manifold 100. In such embodiments, one or more first portions 114a of an attachment mechanism 114 are arranged at the covering 110 and one or more second portions 114b of an attachment mechanism 114 are arranged at the covering 110. The first portions 114a at the covering 110 are connectable to the corresponding second portions 114b at the covering 110 to removably couple or attach the covering 110 to the manifold 100. In embodiments where the first and second portions 114a, 114b of the attachment mechanisms 114 mounted to the covering 110 are connectable to one another, the covering 110 is configured to wrap about an entire periphery the manifold 100 at the location of the attachment mechanisms 114. Further, in embodiments where both the first portion 114a and the second portion 114b of an attachment mechanism 114 located at the covering 110 are connectable to one another, to perform maintenance on the manifold 100, the manifold 100 and the respective covering 110 affixed thereto may be removed from the manifold cavity 106 separately or simultaneously.

In other embodiments, only part of an attachment mechanism 114 is arranged at the covering 110. As a result, the one or more portions 114a, 114b of an attachment mechanism 114 arranged at the covering 110 are not connectable to one another. For example, the covering 110 may include only a first portion of each respective attachment mechanism 114 for mounting the covering 110 about the manifold 100 or only a second portion of each respective attachment mechanism 114 for mounting the covering 110 about the manifold 100. Embodiments where the covering 110 includes a first portion 114a of some attachment mechanisms 114 and a second portion 114b of other attachment mechanisms are also within the scope of the disclosure. However, in such embodiments, the portions 114a, 114b of the attachment mechanisms 114 at the covering 110 are not intended to connect to one another. Rather, the portions 114a, 114b of the attachment mechanisms 114 are connectable to complementary portions 114a, 114b of the attachment mechanisms 114 arranged at another location.

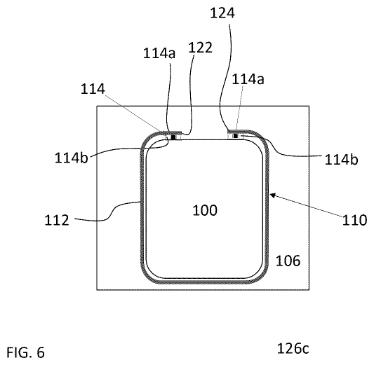

In the non-limiting embodiment shown in FIG. 6, the covering 110 is connected directly to the manifold 100 and therefore is removable separately from or with the manifold 100 from the manifold cavity 106. As shown, a portion of one or more attachment mechanisms 114 may be arranged at the manifold 100. In the non-limiting embodiment of FIG. 6, the first portion 114a of at least one attachment mechanism 114 is located at the body 112 of the covering 110 and the second portion 114b of at least one attachment mechanism is arranged at a surface of the manifold 100. The second portion 114b may be arranged at any suitable location of the manifold 100 that does not interfere with operation of the injection molding apparatus 20 or the positioning of the manifold 100 in the manifold cavity 106. In such embodiments, the covering 110 does not wrap about an entire periphery of the manifold at the location of the attachment mechanisms 114.

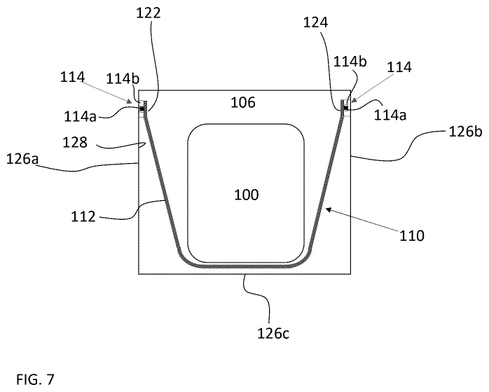

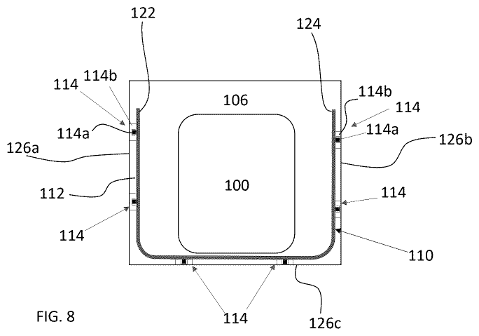

With reference to FIGS. 7 and 8, in other embodiments, at least a portion of the covering 110 is mountable about the manifold 100 but is not connected to the manifold. In such embodiments, at least a portion of the covering 110 is mountable to a component other than the manifold 100. As shown, the covering 110 may be connectable to one or more sidewalls that define a portion of the manifold cavity 106 within which the manifold 100 is received. For example, a first portion 114a of an attachment mechanism 114 arranged at the body 112 of the covering 110, such as arranged near an edge 122 of the body 112 for example, may be connectable to a complementary second portion 114b of the attachment mechanism 114 arranged at a first sidewall 126a. In the illustrated, non-limiting embodiment, the second portion 114b of the attachment mechanism 114 is arranged at an inwardly facing surface 128 of the first sidewall 126a. However, embodiments where the second portion 114b of the attachment mechanism 114 is arranged at another location or is as embedded within a recess formed in the first sidewall 126a for example, are also contemplated herein.

In the illustrated, non-limiting embodiments of FIGS. 7 and 8, both opposing edges 122, 124 of the covering 110 are affixed via one or more attachment mechanisms 114 to first and second sidewalls 126a, 126b of the manifold cavity 106. Although the opposing edges 122, 124 are illustrated as being connectable to different sidewalls of the manifold cavity 106, for example opposing sidewalls, it should be appreciated that when attached, the opposing edges 122, 124 of the covering 110 may be attached to adjacent sidewalls, or alternatively, to the same sidewall.

The attachment mechanism 114 formed via the interface of the first portions 114a and the second portions 114b, respectively, may be positioned to locate the covering 110 as close to the surface of the manifold 100 as possible to form a liner about at least a portion of the manifold 100 (FIG. 7). However, in other embodiments, such as shown in FIG. 8, the covering 110 may be configured as a liner of the manifold cavity 106. In such embodiments one or more attachment mechanisms 114 may be arranged at a central portion of the covering 110 to couple the central portion of the covering 110 to one or more surfaces of the manifold cavity 106. In an embodiment, the covering 110 is affixed to at least one sidewall of the manifold cavity 106 such that the covering 110 wraps about a substantial portion, and in some embodiments about the entire inner perimeter of the manifold cavity 106. For example, as shown, the covering 110 may be affixed within the manifold cavity 106 via at least one attachment mechanism 114 disposed at each of a first sidewall 126a, a second, opposite sidewall 126b, and another sidewall 126c extending between the first and second sidewalls 126a, 126b. In such embodiments, at least a portion of the covering 110, and in some embodiments, the substantially entire covering 110, is spaced away from a surface of the manifold 100.

In embodiments where the covering 110 is at least partially coupled to a sidewall 126 of the manifold cavity 106, the first and second portions 114a, 114b of one or more attachment mechanisms 114 may be decoupled to access the manifold 100. Accordingly, the covering 110 may be separated or moved from its position about at least a portion of the manifold 100 prior to removing the manifold 100 from the manifold cavity 106. In such embodiments, the covering 110 may remain within the manifold cavity 106 even after the manifold 100 has been separated therefrom.

Although a first portion 114a of an attachment mechanism 114 has generally been described herein as being arranged at the covering 110, and a second portion 114b of the attachment mechanism 114 has been arranged at any of the covering 110, a sidewall 126a, 126b, 126c of the manifold cavity 106, or at the manifold 100 itself, it should be understood that in other embodiments, the second portion 114b of the attachment mechanism 114 may be arranged at the covering 110, and the first portion 114a of the attachment mechanism 114 may be arranged at any of the covering, a sidewall 126a, 126b, 126c of the manifold cavity 106, or at the manifold 100 itself. Further, it should be understood that any combination of locations of the portions 114a, 114b of the attachment mechanisms 114 is contemplated herein. For example, a first portion 114a of an attachment mechanism 114 located at the covering 110, such as at a first edge 122 of the covering 110 for example, may be connected to a second portion 114b of an attachment mechanism 114 located at the manifold 100, and a first portion 114a of another attachment mechanism 114 located at the covering 110, such as near a second, opposite edge 124 of the covering 110 for example, may be connectable to a second portion 114b arranged at a sidewall 126b or at another portion of the covering 110. Further, it should be appreciated that in some embodiments where the covering 110 includes at least one first portion 114a and at least one second portion 114b of an attachment mechanism, the portions 114a, 114b may be connectable to one another or to respective portions of an attachment mechanism located at another location, such as a sidewall 126 or the manifold cavity 106 for example.

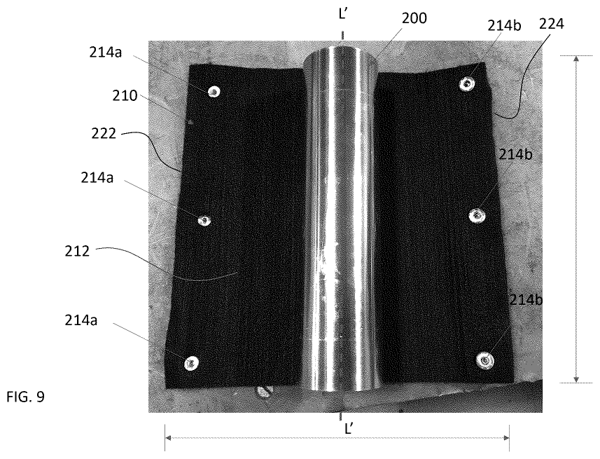

Although the various configurations of a covering 110 shown in FIGS. 2-8 are described herein with respect to a manifold 100, it should be appreciated that a similar covering may alternatively or additionally be attached to one or more other components associated with the injection flow path of the injection molding system 20. With reference to FIGS. 9-12, an example of a covering 210 for use with a nozzle 200, similar to nozzle 40 is illustrated. The covering 210 may be formed from any of the materials or combination of materials identified above with respect to covering 110. Further, in embodiments where both a manifold 100 of an injection molding system includes a covering 110 and a nozzle 200 of the injection molding system includes a covering 210, the covering 210 may but need not be formed from the same material as the covering 110 of the manifold 100. Additionally, the coverings 110, 210 may be separate from one another, or alternatively, may be connectable to one another or even integrated as a unitary body.

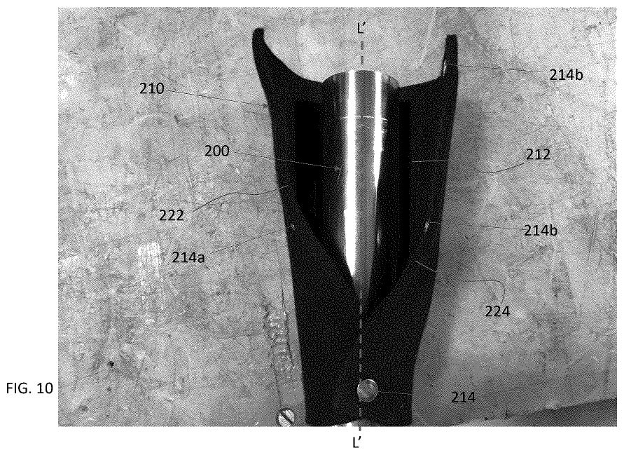

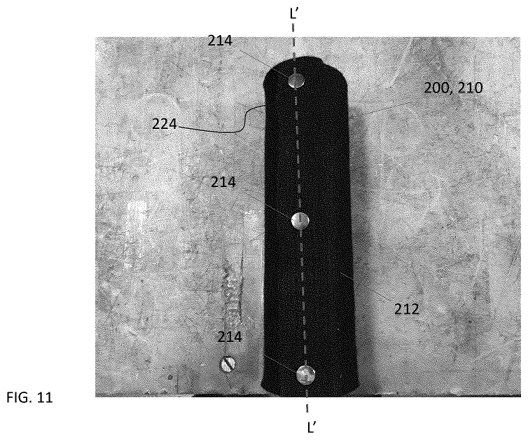

The covering 210 associated with the nozzle 200 is generally complementary to at least a portion, and in some embodiments, to a substantial entirety of an outer periphery of the nozzle 200. The body 212 of the covering 210 can be wrapped about an entire periphery of the nozzle 200 at one or more locations along a longitudinal axis L′ of the nozzle 200. In an embodiment, a covering 210, is transformable between a first, uninstalled configuration (FIGS. 9 and 10) and a second, installed configuration (FIG. 11). In the uninstalled configuration, the body 212 of the covering 210 may have a generally planar configuration. In the illustrated, non-limiting embodiment, in the installed configuration, the covering 210 surrounds the substantially entire periphery of the nozzle 200 over an entire length of the nozzle 200 such that a substantial entirety of the nozzle 200 is covered by the covering 210.

Similar to the covering of the manifold described above, the covering 210 associated with a nozzle 200 may include one or more attachment mechanisms 214 operable to affix the covering 210 about the nozzle 200. An attachment mechanism 214 may have a first portion 214a and a second portion 214b complementary and connectable to one another. Examples of suitable attachment mechanisms 214 include, but are not limited to, snaps, hook and loop fasteners, such as Velcro®, buckles, twist fasteners, ties, grommets, buttons, zippers, and magnets. For example, the stud of a snap may be considered a first portion and a cap of a snap may be considered a second portion. Similarly, the hook side of a fastener may be considered the first portion and the loop side of a fastener may be considered a second portion, or a magnet having a first polarity may be considered a first portion and a magnet having a second polarity may be considered a second portion. In embodiments where a manifold 100 of an injection molding system includes a covering 110 and a nozzle 200 of the injection molding system includes a covering 210, the at least one attachment mechanism 214 of the covering 210 may be similar to, or alternatively, may be a different type than the at least one attachment mechanism 114 of the covering 110.

In the illustrated, non-limiting embodiment of FIGS. 9-11, a plurality of first portions 214a are arranged along a first edge 222 of the body 212 of the covering 210 and a plurality of second portions 214 are generally arranged at or along an opposite edge 224 of the body 212. The edges 222, 224 may be oriented parallel to the longitudinal axis L′ of the nozzle 200 for example. However, it should be understood that the positioning of attachment mechanisms 214 about the body 212 of the covering 210 may depend on the type of attachment mechanism 214 being used and the desired amount of wrap of the covering 210 about the nozzle 200. In the illustrated, non-limiting embodiment of FIG. 11, the first portion 214a of each attachment mechanism 214 is connectable to a corresponding second portion 214b of an attachment mechanism 214 arranged at the covering 210. Accordingly, the covering 210 is configured to wrap about the nozzle 200 and couple to itself. In such embodiments, to perform maintenance on the nozzle 200, the nozzle 200 and the respective covering 210 affixed thereto may be removed from the system simultaneously. However, in other embodiments, a portion of an attachment mechanism 214 may be arranged at another location, such as at an exterior surface of the nozzle 200 itself, or at a surface of a wall surrounding the nozzle 200 when installed.

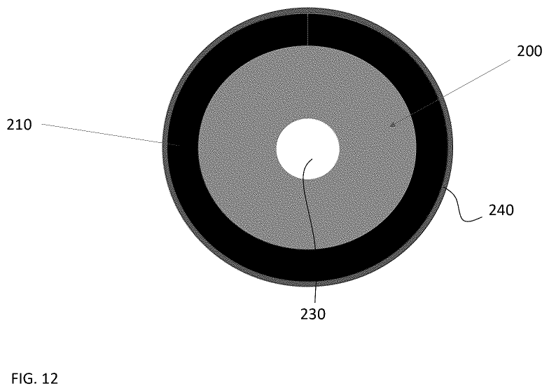

In some embodiments, the covering 210 itself may not include an attachment mechanism 214 or a portion thereof. Rather, an attachment mechanism completely separate from the covering may be used to removably couple the covering 210 to the nozzle 200. With reference to FIG. 12, an outer sleeve or outer casing 240 may be positioned in overlapping arrangement with a covering 210 installed about a nozzle 200 to couple the covering to the nozzle 200. This engagement between the sleeve 240 and the covering 210 may restrict movement or separation of the covering 210 from the nozzle 200. A sleeve 240 as illustrated and described herein a may be formed from any suitable rigid or semi-rigid material, such as metal or plastic for example.

As shown in FIG. 12, the nozzle 200 has a central nozzle channel 230 formed therein, and a covering 210 is wrapped about the entire periphery of the nozzle 200. It should be appreciated that the covering 210 need not wrap about the entire periphery of the nozzle 200 and may have any configuration as described above. In the illustrated, non-limiting embodiment, the sleeve 240 is a cylindrical body that similarly wraps about an entire periphery of both the nozzle 200 and the covering 210. However, in other embodiments, the sleeve 240 may extend about only a portion of the periphery of the nozzle 200 and covering 210. For example, the sleeve 240 may wrap about more than 200 degrees and less than 360 degrees of the periphery. In such embodiments, the overall wrap may be selected to maintain sufficient engagement between the covering 210 and the sleeve 240 to restrict movement of the sleeve 240 and covering relative to the nozzle 200.

The sleeve 240 may be mounted concentrically with the nozzle 200 and covering 210 about the longitudinal axis L′ and an inner diameter of the sleeve 240 may be substantially equal to the outer diameter of the nozzle 200 wrapped by the covering 210. In other embodiments, the inner diameter of the sleeve 240 may be slightly smaller than the outer diameter of the nozzle 200 wrapped by the covering 210. In such embodiments, the covering 210 may be partially compressed by the sleeve 240 when the sleeve 240 is installed thereabout. In an embodiment, the nozzle 200 and covering 210 are slidably received within and decoupled from the sleeve 240. Further, the sleeve 240 may extend over only a portion of a length of the nozzle 200, parallel to axis L′, or alternatively, may extend over the entire length of the nozzle 200.

The configuration of the sleeve 240 may be uniform over its length or alternatively may vary. In an embodiment, the sleeve 240 is configured to wrap about a first portion of a periphery of the covering 210 at a first location along the axis L′ and is configured to wrap about a second portion of the periphery of the covering 210 at a second location spaced from the first location along the axis L′. The first portion and the second portion have different radial locations relative to the longitudinal axis L′ and/or may include different degrees of wrap about the covering 210. Accordingly, it should be appreciated that various parameters of the sleeve 240 may be modified while retaining sufficient surface area engageable with the covering 210 to restrict movement of the covering 210 relative to the nozzle 200.

An insulative covering 110, 210 as described herein will restrict heat loss of a corresponding component of an injection molding system 20 while also being easily removable to provide access to the component when required.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An injection molding apparatus comprising:
a cavity;
a component removably mountable within the cavity; and
a covering, the covering being positionable about the component, wherein the covering and the component are removably installable within the cavity.

2. The injection molding apparatus of claim 1, wherein the covering extends about an entire periphery of the component at one or more locations along a longitudinal axis of the component.

3. The injection molding apparatus of claim 1, wherein the covering extends about only a portion of a periphery of the component at one or more locations along a longitudinal axis of the component.

4. The injection molding apparatus of claim 1, wherein the covering forms a liner about the cavity.

5. The injection molding apparatus of claim 1, wherein the covering further comprises:
a body formed from a non-rigid, insulative material; and
a first portion of at least one attachment mechanism affixed to the body, the first portion of the at least one attachment mechanism being connectable to a second portion of the at least one attachment mechanism to position the covering about the component.

6. The injection molding apparatus of claim 5, wherein the second portion of the at least one attachment mechanism is affixed to the body.

7. The injection molding apparatus of claim 5, wherein the second portion of the at least one attachment mechanism is affixed to a sidewall of the cavity.

8. The injection molding apparatus of claim 5, wherein the second portion of the at least one attachment mechanism is affixed to the component.

9. The injection molding apparatus of claim 1, wherein the component is a manifold.

10. The injection molding apparatus of claim 1, wherein the component is a nozzle.

11. The injection molding apparatus of claim 1, further comprising an attachment mechanism separate from the covering, the attachment mechanism being positionable in overlapping arrangement with the covering to removably couple the covering to the component.

12. The injection molding apparatus of claim 1, wherein the covering is formed from a carbon felt material.

13. A covering for use with a component of an injection molding apparatus, the covering comprising:
a body formed from a non-rigid, insulative material; and
a first portion of at least one attachment mechanism affixed to the body, the first portion of the at least one attachment mechanism being removably engageable with a second portion of the at least one attachment mechanism, wherein when the first portion of the at least one attachment mechanism is connected to the second portion of the at least one attachment mechanism, at least a portion of the component is surrounded by the body.

14. A method of performing maintenance on a component of an injection molding apparatus, the method comprising:
accessing a cavity within which the component is positioned;
removing the component from the cavity;
decoupling at least one attachment mechanism to separate a covering from the component; and
recoupling the covering to the component via the at least one attachment mechanism.

15. The method of claim 14, wherein decoupling the at least one attachment mechanism includes separating a first portion of the at least one attachment mechanism from a second portion of the at least one attachment mechanism.

16. The method of claim 15, wherein the second portion of the at least one attachment mechanism is affixed to the covering.

17. The method of claim 15, wherein the second portion of the at least one attachment mechanism is affixed to the component.

18. The method of claim 15, wherein the second portion of the at least one attachment mechanism is affixed to a sidewall of the cavity.

19. The method of claim 15, wherein the covering remains within the cavity during the removing the component from the cavity.

20. The method of claim 14, wherein decoupling at least one attachment mechanism includes sliding the at least one attachment mechanism out of engagement with the covering.
